(19) United States
(12) Patent Application Publication
(10) Pub. No.: US 2020/0260762 A1
(43) Pub. Date: Aug. 20, 2020

(54) A MICROWAVE OVEN WITH DRYING FUNCTION

(71) Applicant: ARCELIK ANONIM SIRKETI, Istanbul (TR)

(72) Inventors: Sezgi YIKILMAZCINAR, Istanbul (TR); Metin GUR, Istanbul (TR); Merve GUVEN, Istanbul (TR); Serdal ELMAS, Istanbul (TR); Haluk KARATAS, Istanbul (TR)

(21) Appl. No.: 16/066,047

(22) PCT Filed: Nov. 30, 2016
(86) PCT No.: PCT/EP2016/079263

§ 371 Date: Jun. 25, 2018

(30) Foreign Application Priority Data
Dec. 29, 2015 (TR) 2015/17279

(51) Int. Cl. A23L 3/54; H05B 6/64; H05B 6/80; A23B 7/02

(52) U.S. Cl. CPC A23L 3/54; H05B 6/6408; A23V 2002/00; A23B 7/02; H05B 2206/046; H05B 6/80

(57) ABSTRACT

Embodiments provide a microwave oven comprising a microwave generator, a control unit that controls the microwave generator, and a tray that has an aperture arranged at the center thereof where the microwave density is higher than the edges, and whereon the foodstuffs such as vegetables and fruits to be dried are placed.

The present invention relates to a microwave oven wherein especially foodstuffs such as fruits and vegetables are dried.

In order to dry various foodstuffs, especially vegetables and fruits, in a microwave oven, specially formed drying trays are used. In the microwave ovens, the density of the electromagnetic field acting on the central part of the drying tray is higher than the edges of the tray. The foodstuffs placed in the center of the drying tray where the microwave density is higher dry quicker, while a longer period is needed on the edges and corners where the microwave density is lower. When drying of the foodstuffs placed on the edges and corners is completed, the foodstuffs in the center are observed to have burnt. In the state of the art embodiments, the central part of the tray where the density of the electromagnetic field is high is left empty.

There are a number of embodiments wherein the moisture in the volume in the microwave oven can be discharged. In order to discharge the moisture, an exhaust outlet, a chimney and a fan are used in the volume. Thus, both the quality of the drying process is improved and the drying time is decreased. However, this embodiment raises difficulties in terms of producibility while increasing costs. Generally, in cases wherein this type of drying is carried out, the foodstuffs lose 70%-85% of their moisture by mass. Therefore, vapor accumulates in the volume of the microwave oven and the drying performance is adversely affected. In case the moisture is discharged from the volume by means of a fan and an exhaust outlet, a drying speed of 20%-30% and an improved drying are obtained.

In the state of the art Great Britain Patent Application No. GB2236646, a microwave oven comprising a tray whereon kitchen utensils are placed and dried is disclosed.

The aim of the present invention is the realization of a microwave oven wherein the moisture generated during the drying process is discharged.

The microwave oven realized in order to attain the aim of the present invention, explicated in the first claim and the respective claims thereof comprises a tray (drying tray) that is produced from a microwave permeable material, that has an aperture at the center thereof wherein the microwave density is high and wherein the foodstuffs such as vegetables and fruits to be dried are placed at the regions around the aperture, and at least one desiccant block that is placed into the tray and that is produced from a microwave permeable ceramic material with desiccant properties.

In various embodiments of the present invention, the desiccant block is placed onto the upper side of the tray by being seated into the aperture at the center of the tray and/or at the underside of the base of the tray and/or at the side walls.

By means of the present invention, the moisture generated due to the drying process is enabled to be quickly discharged without adversely affecting the microwave density in the microwave oven.

The microwave oven realized in order to attain the aim of the present invention is illustrated in the attached figures, where:

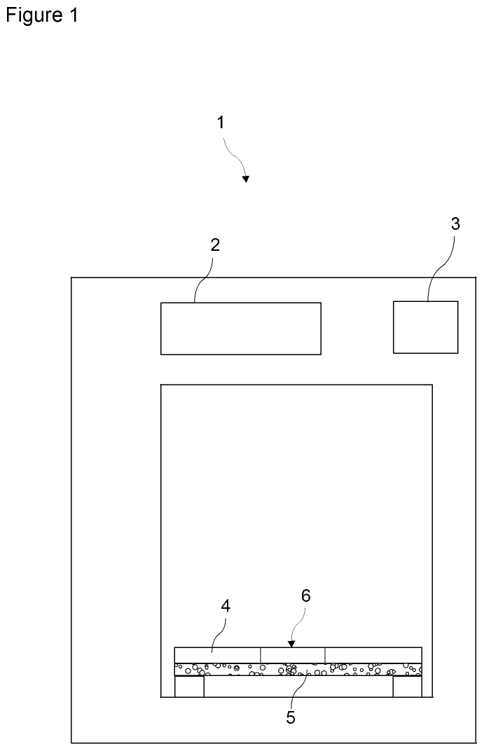

FIG. 1—is the schematic view of the microwave oven of the present invention.

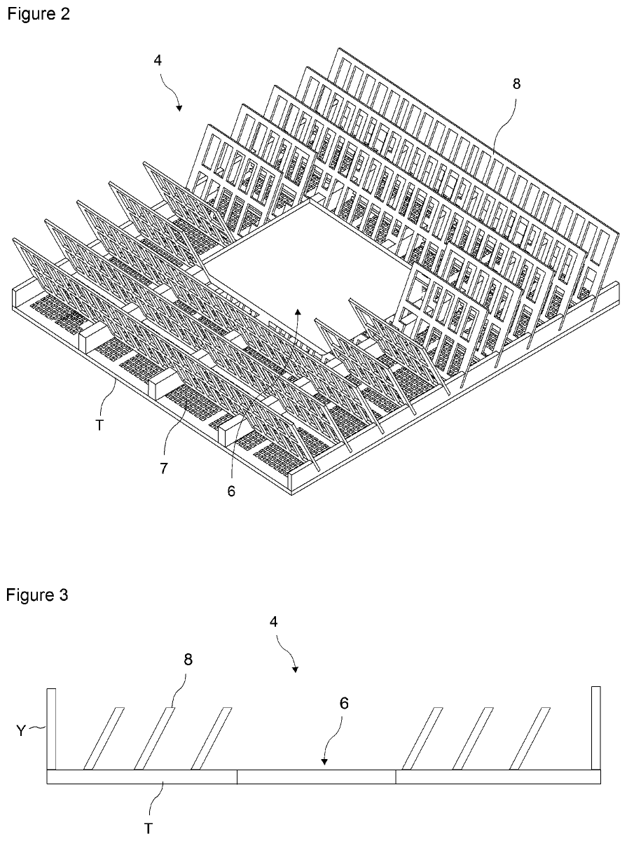

FIG. 2—is the perspective view of a tray that is used in the drying process and that has an aperture at the center thereof.

FIG. 3—is a schematic of the tray in FIG. 2.

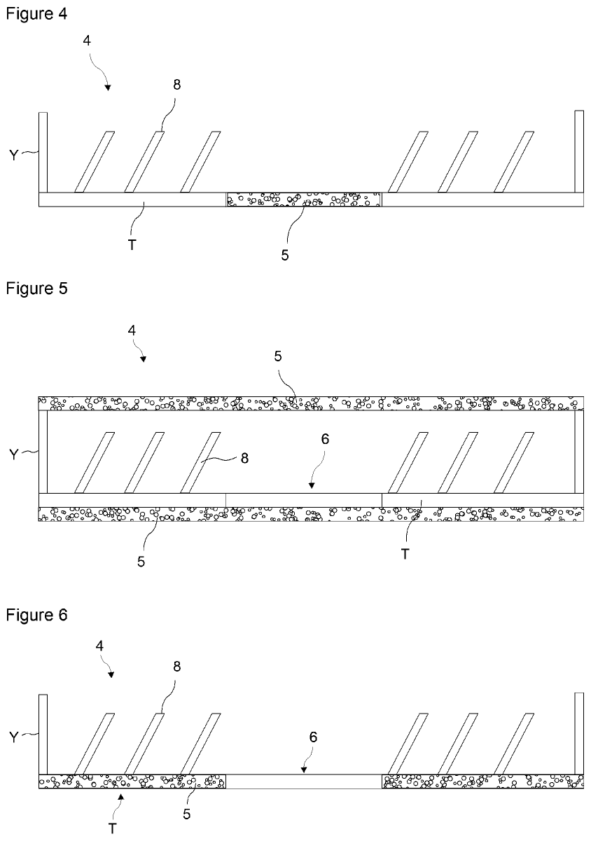

FIG. 4—is the schematic view of a tray wherein the desiccant block is placed into the aperture at the center thereof.

FIG. 5—is the schematic view of a tray wherein two desiccant blocks are placed at the upper and underside thereof.

FIG. 6—is the schematic view of a tray of which the base is produced from the material of the desiccant block.

The elements illustrated in the figures are numbered as follows:
1. Microwave oven
2. Microwave generator
3. Control unit
4. Tray
5. Desiccant block
6. Aperture
7. Hole
8. Support
T: Base of the drying tray
Y: Side walls of the drying tray

The microwave oven (1) comprises a microwave generator (2), a control unit (3) that controls the microwave generator (2), and a tray (4) that has an aperture (6) arranged at the center thereof where the microwave (electromagnetic energy) density is higher than the edges, and whereon the foodstuffs such as vegetables and fruits to be dried are placed.

The microwave oven (1) of the present invention comprises one or more than one desiccant block (5) that is disposed on the tray (4).

The foodstuffs to be dried in the microwave oven (1) are placed around the aperture (6) on the tray (4). While the foodstuffs are dried with the microwave energy, the moisture generated during the drying process is sucked by the desiccant block (5) disposed on the tray (4) and thus removed from the environment, and the drying process is accelerated.

The tray (4) furthermore comprises holes in such size to allow the passage of the electromagnetic energy and one or more than one support (8) that enables the foodstuffs to be kept in an orderly manner (FIG. 3).

In an embodiment of the present invention, the microwave oven (1) comprises the desiccant block (5) that is fixed to the tray (4) and that is produced from a material that is both microwave permeable, in other words ineffective in terms of microwaves, and that has desiccant properties. Since the desiccant block (5) does not prevent the microwaves, the drying efficiency of the microwave oven (1) is not adversely affected.

In an embodiment of the present invention, the desiccant block (5) is produced from ceramic material that has preferably a porous structure. In other embodiments of the present invention, the desiccant block (5) is produced from materials comprising cordierite or pizza stone.

In another embodiment of the present invention, the desiccant block (5) is disposed into the aperture (6) arranged at the center of the tray (4) (FIG. 4).

In another embodiment of the present invention, the desiccant block (5) is disposed at the underside of the base (T) of the drying tray (4) (FIG. 5).

In another embodiment of the present invention, the base (T) of the drying tray (4) is directly produced from the material of the desiccant block (5) (FIG. 6).

In another embodiment of the present invention, the desiccant block (5) is disposed at the upper side of the tray (4) by being seated onto the side walls (Y) of the drying tray (4) (FIG. 5).

The desiccant blocks (5) of the present invention enable the amount of desiccation during the drying process in the microwave oven (1) to be increased, thus realizing a quick and efficient drying process.

1. A microwave oven comprising a microwave generator, a control unit that controls the microwave generator, and a tray that has an aperture arranged at the center thereof where the microwave density is higher than the edges, and whereon the foodstuffs such as vegetables and fruits to be dried are placed, characterized by one or more than desiccant block that is disposed on the tray.

2. The microwave oven as in claim 1, characterized by the tray comprising holes in such size to allow the passage of electromagnetic energy and one or more than one support that enables the foodstuffs to be kept in an orderly manner.

3. The cooling device as in claim 1, characterized by the desiccant block that is produced from a material that is microwave permeable and that has desiccant properties.

4. The microwave oven as in claim 3, characterized by the desiccant block that is produced from ceramic material.

5. The microwave oven as in claim 3, characterized by the desiccant block that is produced from a material comprising cordierite.

6. The microwave oven as in claim 3, characterized by the desiccant block that is produced from a material comprising pizza stone.

7. The microwave oven as in claim 1, characterized by the desiccant block that is disposed into the aperture.

8. The microwave oven as in claim 1, characterized by the desiccant block that is disposed at the underside of the base of the drying tray.

9. The microwave oven as in claim 1, characterized by the drying tray the base of which is produced from the material of the desiccant block.

10. The microwave oven as in claim 1, characterized by the desiccant block that is disposed at the upper side of the tray by being seated onto the side walls of the drying tray.
